(19) United States
(12) Patent Application Publication
(10) Pub. No.: US 2025/0385449 A1
(43) Pub. Date: Dec. 18, 2025

(54) ELECTRICAL CONNECTOR ASSEMBLY

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: WEI-YANG CHEN, New Taipei (TW); MING-CHUAN WU, New Taipei (TW)

(21) Appl. No.: 19/237,393

(22) Filed: Jun. 13, 2025

(30) Foreign Application Priority Data
Jun. 14, 2024 (CN) 202421366031.4

(51) Int. Cl. H01R 12/70; H01R 12/71; H01R 13/502; H01R 13/533

(52) U.S. Cl. CPC H01R 12/707; H01R 12/7052; H01R 12/7082; H01R 12/716; H01R 13/502; H01R 13/533

(57) ABSTRACT

An electrical connector assembly includes a metal cage and a receptacle connector. The metal cage includes: a top wall; a pair of side walls extending downwardly from two sides of the top wall; and a rear wall connected to the top wall and the pair of side walls, the top wall, the pair of side walls, and the rear wall cooperated to form a receiving space with a front opening. The receptacle connector is received in the receiving space and includes plural soldering feet for soldering on an external circuit board, wherein each of the pair of side walls and the rear wall has a slot.

### BACKGROUND OF THE INVENTION

### Field of the Invention

The present invention relates generally to an electrical connector assembly, and particularly to an electrical connector assembly that can be soldered on a circuit board.

### Description of Related Arts

U.S. Pat. No. 10,942,322 discloses an electrical connector assembly that can be mounted on an external circuit board, comprising a metal cage, a receptacle connector received in the metal cage, and a heat sink disposed on an outer wall of the metal cage. When the electrical connector assembly is soldered on the external circuit board through a high-temperature furnace, the metal cage and the receptacle connector pass through the high-temperature furnace together. Since soldering tails of the receptacle connector are surrounded by the metal cage and the heat sink absorbs most of the heat, the soldering tails of the receptacle connector may be poorly soldered due to uneven heat.

An improved electrical connector assembly is desired.

### SUMMARY OF THE INVENTION

The objective of the present invention is to provide an electrical connector assembly that can be reliably soldered on an external circuit board.

To achieve the above object, an electrical connector assembly comprises: a metal cage comprising: a top wall; a pair of side walls extending downwardly from two sides of the top wall; and a rear wall connected to the top wall and the pair of side walls, the top wall, the pair of side walls, and the rear wall cooperated to form a receiving space with a front opening; and a receptacle connector received in the receiving space and comprising a plurality of soldering feet for soldering on an external circuit board, wherein each of the pair of side walls and the rear wall has a slot.

Compared to prior art, in the electrical connector assembly of the present invention, by providing slots on the side walls and the rear wall, hot air can flow between the slot on the rear wall and the slots on the side walls, thereby avoiding poor soldering when the electrical connector assembly is soldered on the external circuit board.

### BRIEF DESCRIPTION OF THE DRAWING

FIG. 1 is a perspective view of an electrical connector assembly according to the present invention mounted on an external circuit board;

FIG. 2 is a top view of the electrical connector assembly of FIG. 1 mounted on the external circuit board;

FIG. 3 is a perspective view of the electrical connector assembly of FIG. 1;

FIG. 4 is an exploded of the electrical connector assembly of FIG. 3;

FIG. 5 is another exploded view of the terminal module of FIG. 4;

FIG. 6 is a perspective view of the metal cage of the electrical connector assembly of FIG. 4;

FIG. 7 is another exploded view of the metal cage of FIG. 6;

FIG. 8 is an exploded p view of the metal cage of FIG. 7;

FIG. 9 is a side view of the electrical connector assembly FIG. 1, mounted on the external circuit board;

FIG. 10 is another side view of the electrical connector assembly FIG. 9, mounted on the external circuit board;

FIG. 11 is a rear view of the the electrical connector assembly of FIG. 9, mounted on the external circuit board;

FIG. 12 is a side view of the metal cage of FIG. 6;

FIG. 13 is another side view of the metal cage of FIG. 12; and

FIG. 14 is a rear view of the metal cage of FIG. 12.

### DETAILED DESCRIPTION OF THE PREFERRED EMBODIMENT

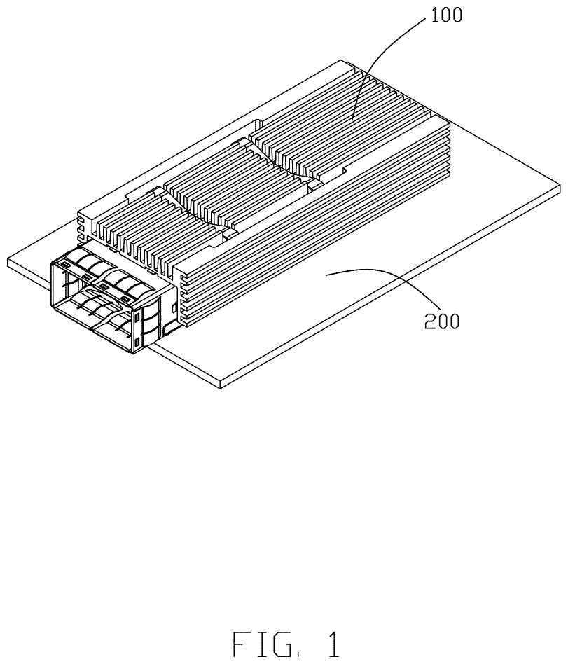

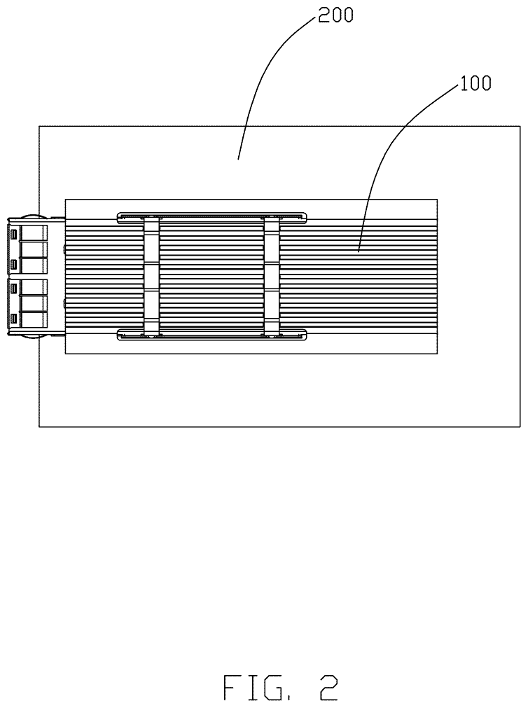

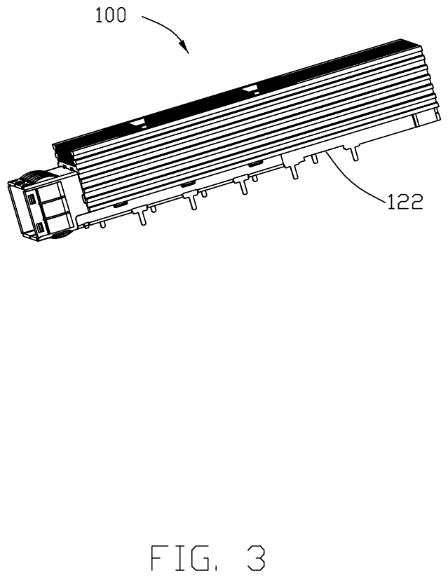

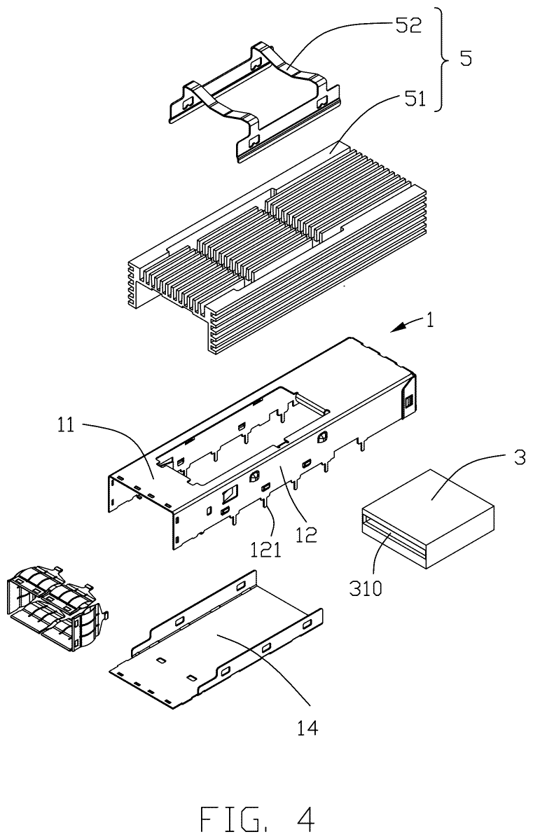

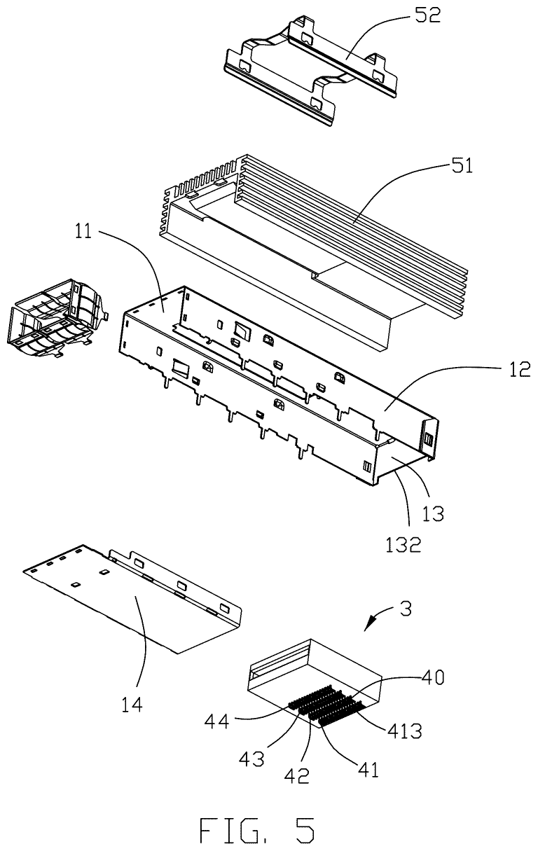

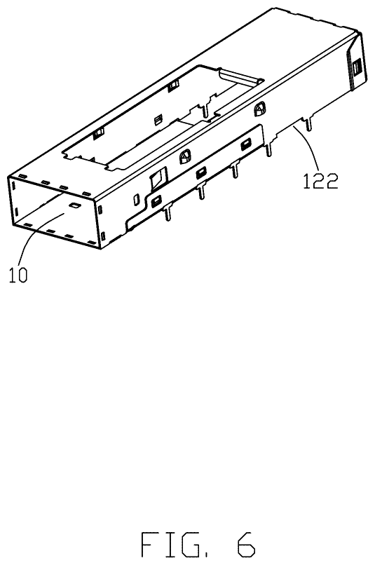

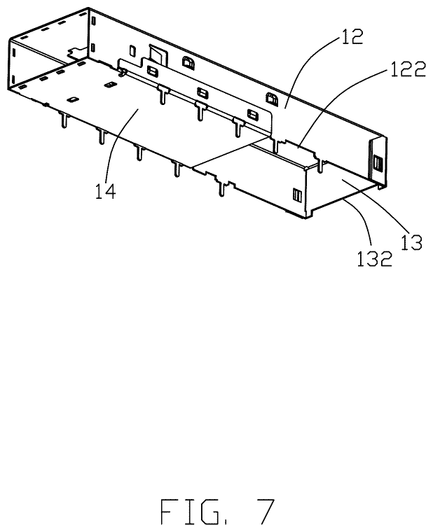

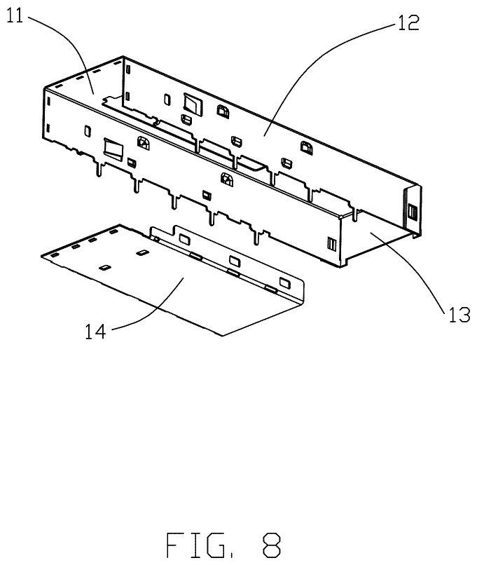

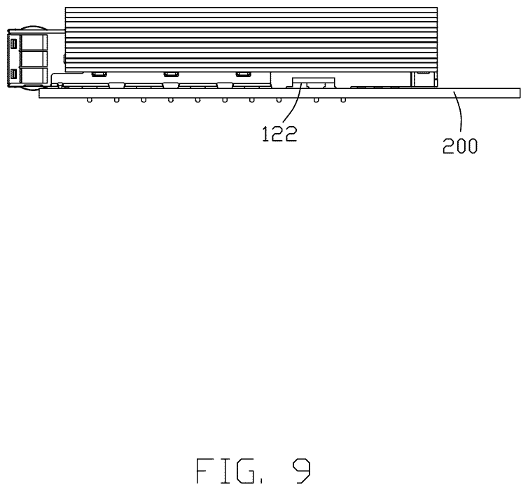

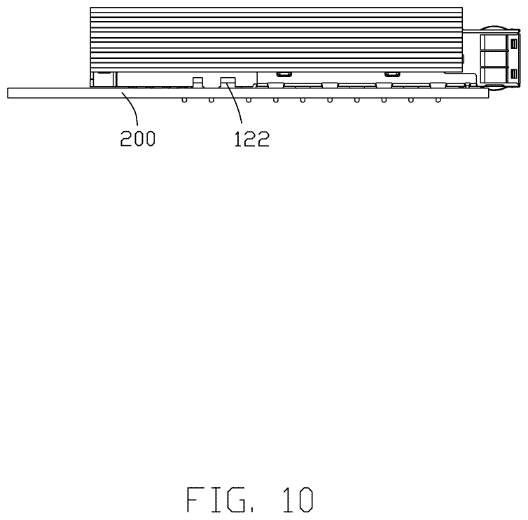

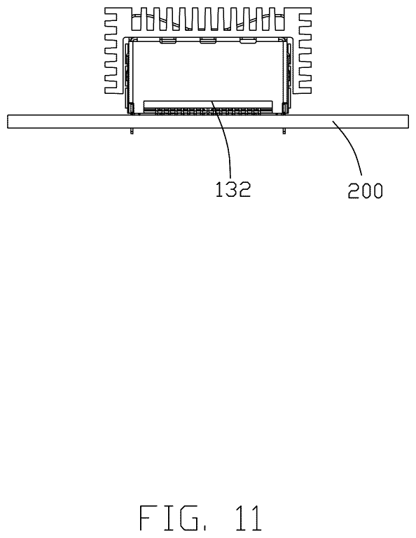

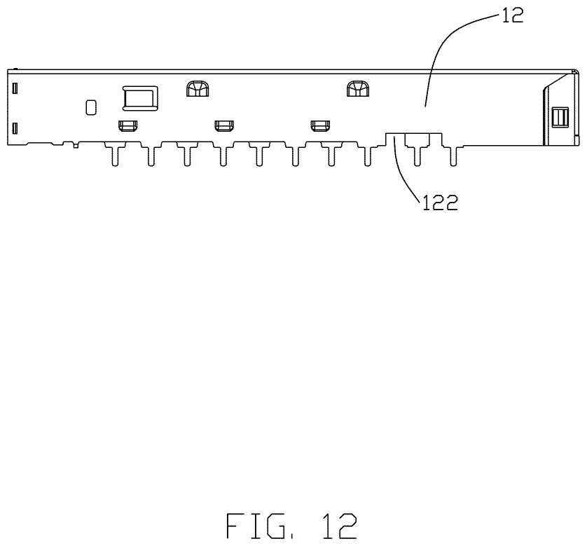

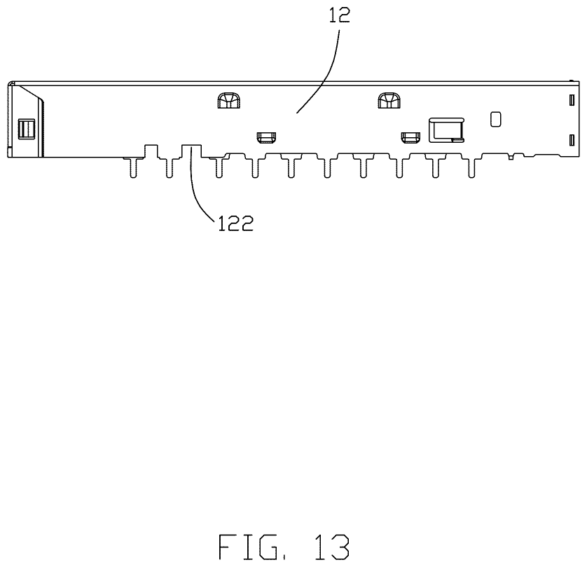

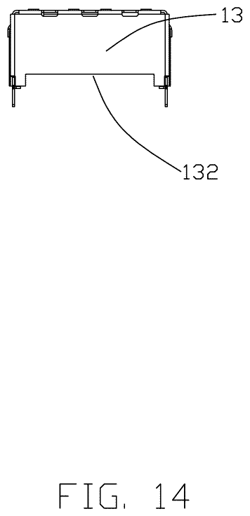

Referring to FIGS. 1-14, an electrical connector assembly 100 in accordance with the present invention is shown. The electrical connector assembly 100 can be mounted on an external circuit board 200 by soldering and can be inserted and matched with a mating plug module (not shown). The electrical connector assembly 100 includes a metal cage 1, a receptacle connector 3 received in the metal cage 1, and a heat dissipation device 5 disposed outside the metal housing 1.

The metal cage 1 includes a top wall 11, a pair of side walls 12 extending downwardly from two sides of the top wall 11, a rear wall 13, and a bottom wall 14 parallel to the top wall 12. The top wall 11, the pair of side walls 12, and the rear wall cooperated to form a receiving space 10 with a front opening. After the electrical connector assembly 100 is mounted on the external circuit board 200, the bottom wall 14 is parallel to the external circuit board 200 but not contact the external circuit board 200. The rear wall 13 is assembled and fixed to the rear of the pair of side walls 12 and the top wall 11. The bottom wall 14 and the pair of side wall 12 are separate structures. The side walls 12 has a plurality of mounting feet 121 extending downward for mounting on the external circuit board. The lower side of each of the side walls 12 has a slot 122, and the lower side of the rear wall 13 has a slot 132. When the electrical connector assembly 100 is soldered on the external circuit board 200 through a high-temperature furnace, hot air flows between the slot 132 of the rear wall 13 and the slots 122 of the side walls 12. Specifically, the hot air enters from the slot 132 of the rear wall 13 and flows out from the slots 122 of the side walls 12.

The receptacle connector 3 includes an insulative housing 30 and a terminal module 40 received in the insulative housing 30. The insulative housing 30 includes a mating slot 310 for a mating tongue of the plug module to be inserted. The receptacle connector 3 is received in the receiving space 10 and is located at the rear of the receiving space 10. The plug module can be inserted through the front opening and mated with the receptacle connector 3. The bottom wall 14 does not extend backward to the rear wall 13, so that the receptacle connector 3 can be mounted downward on the external circuit board 200. The terminal module 40 includes a first row of terminals 41, a second row of terminals 42, a third row of terminals 43, and a fourth row of terminals 44. Each of the terminals includes a contact portion (not shown) extending forward to cooperate with the mating tongue of the plug module and a soldering foot 413 extending downwardly out of the insulative housing 30 for soldering on the external circuit board 200. The contact portions of the first row of terminals 41 and the second row of terminals 42 are arranged on the upper side of the mating slot 310. The contact portions of the third row of terminals 43 and the fourth row of terminals 44 are arranged on the lower side of the mating slot 310. The first row of terminals 41 and the fourth row of terminals 44 form a front mating port. The second row of terminals 42 and the third row of terminals 43 form a rear mating port. The front mating port and the rear mating port are arranged in a front-to-back direction to cooperate with a same mating tongue.

The soldering feet 413 of the first row of terminals 41 are arranged in a first row along a transverse direction, the soldering feet 413 of the second row of terminals 42 are arranged in a second row along a transverse direction, the soldering feet 413 of the third row of terminals 43 are arranged in a third row along a transverse direction, and the soldering feet 413 of the fourth row of terminals 44 are arranged in a fourth row along a transverse direction. The soldering feet 413 of the first row of terminals 41 to the fourth row of terminals 44 are arranged in sequence from back to the front. The bottom surfaces of the soldering feet 413 of the four rows of terminals are located in a same plane. The slots 122 of the side walls 12 are located in front of the soldering feet 413 in the front-to-back direction. Specifically, the slots 122 of the side walls 12 are located in front of the soldering feet 413 of the fourth row in the front-to-back direction and are located at rear of the bottom wall 14 in the front-to-back direction. Each of the slots 122 is higher than the bottom surface of the soldering feet 413. There is no slot on the side walls on two sides of the soldering feet in the transverse direction. The lowest sides of the portions of the pair of side walls 12 without the slot is flush with the bottom wall 14. That is, the portion of the side walls 12 that is not provided with a slot extends downward to the bottom wall 14.

During the process of soldering the electrical connector assembly 100 on the external circuit board 200, the rear portion enters the high temperature furnace first. Hot air in the high temperature furnace flows in the opposite direction to the direction in which the electrical connector assembly 100 enters the high temperature furnace. The hot air enters from the bottom slot 132 of the rear wall 13 and exits from the slots 122 of the side walls 12, so that the temperature can quickly reach the melting temperature of the solder during the process of soldering the electrical connector assembly 100 to the external circuit board 200, and the problem of poor soldering will not occur.

The heat dissipation device 5 is installed on a outer side of the top wall 11 and the pair of side walls 12, and the heat dissipation device 5 is not installed on the outside of the rear wall 13. The lowermost side of the heat dissipation device 5 is higher than the slots 122 on the side walls 12. The heat dissipation device 5 includes a heat sink 51 and a clip 52 that crosses the heat sink 51 and snaps with the side walls 12. The clip 52 snaps with the side walls 12 to fix the heat sink 51 on the metal cage 1.

1. An electrical connector assembly comprising:
a metal cage comprising:
a top wall;
a pair of side walls extending downwardly from two sides of the top wall; and
a rear wall connected to the top wall and the pair of side walls, the top wall, the pair of side walls, and the rear wall cooperated to form a receiving space with a front opening; and
a receptacle connector received in the receiving space and comprising a plurality of soldering feet for soldering on an external circuit board, wherein
each of the pair of side walls and the rear wall has a slot.

2. The electrical connector assembly as claimed in claim 1, wherein the metal cage further comprises a bottom wall, and the bottom wall extends rearwardly and is spaced a distance from the rear wall.

3. The electrical connector assembly as claimed in claim 2, wherein the bottom wall and the pair of side walls are separate structures.

4. The electrical connector assembly as claimed in claim 3, wherein the receptacle connector includes an insulative housing and a terminal module received in the insulative housing, the terminal module includes at least one row of soldering feet arranged in a transverse direction, and the slot on each of the side walls is disposed at a rear of the bottom wall in a front-to-back direction.

5. The electrical connector assembly as claimed in claim 4, wherein each of the slots is higher than the bottom surface of the soldering feet.

6. The electrical connector assembly as claimed in claim 4, wherein the slots on the side walls and two sides of the soldering feet are misaligned in the transverse direction.

7. The electrical connector assembly as claimed in claim 4, wherein the slots on the side walls are located in front of the soldering feet in the front-to-back direction.

8. The electrical connector assembly as claimed in claim 4, wherein a lowest portion of the pair of side walls is flush with the bottom wall.

9. The electrical connector assembly as claimed in claim 8, wherein the terminal module comprises a first row of terminals, a second row of terminals, a third row of terminals, and a fourth row of terminals, and each terminal of the first through fourth rows comprises a contact portion and a soldering foot extending downwardly out of the insulative housing for mounting on the external circuit board.

10. The electrical connector assembly as claimed in claim 9, wherein the insulative housing of the receptacle connector comprises a mating slot, the contact portions of the first row of terminals and the second row of terminals are arranged on the upper side of the mating slot, the contact portions of the third row of terminals and the fourth row of terminals are arranged on the lower side of the mating slot, the first row of terminals and the fourth row of terminals form a front mating port, and the second row of terminals and the third row of terminals form a rear mating port.

11. The electrical connector assembly as claimed in claim 10, wherein the soldering feet of the row of terminals of the first through fourth rows are arranged along the transverse direction in sequence from back to front.

12. The electrical connector assembly as claimed in claim 11, wherein the slots of the side walls are located in front of the soldering feet of the fourth row terminal in the front-to-back direction.

13. The electrical connector assembly as claimed in claim 4, further comprising a heat dissipation device installed on an outside of the top wall and the pair of side walls, and wherein a lowermost side of the heat dissipation device is higher than the slots on the pair of side walls.

14. The electrical connector assembly as claimed in claim 13, wherein the heat dissipation device is cleared from an outside of the rear wall.

15. An electrical connector assembly comprising:
a metal cage comprising:
a top wall; and
a pair of side walls extending downwardly from two sides of the top wall; and
a rear wall connecting the top wall and the pair of side walls, the top wall, the pair of side walls, and the rear wall cooperated to form a receiving space with a front opening; and
a receptacle connector received in the receiving space and comprising a plurality of soldering feet, wherein
a respective lower side of each of the pair of side walls and the rear wall has a slot so as to flow hot air between the slot in the rear wall and the slots in the side walls.
